(19) United States
(12) Patent Application Publication
(10) Pub. No.: US 2014/0180892 A1
(43) Pub. Date: Jun. 26, 2014

(54) Mitigating Communication Risks in an Electronic Trading System

(71) Applicant: TRADING TECHNOLOGIES INTERNATIONAL, INC., Chicago, IL (US)

(72) Inventor: Frank Matthew Strehl, Chicago, IL (US)

(73) Assignee: TRADING TECHNOLOGIES INTERNATIONAL, INC., Chicago, IL (US)

(21) Appl. No.: 13/723,011

(22) Filed: Dec. 20, 2012

(51) Int. Cl. G06Q 40/04

(52) U.S. Cl. CPC G06Q 40/04
USPC 705/37

(57) ABSTRACT

Certain embodiments provide methods to mitigate communication risks in an electronic trading system. An example method including monitoring a communication link established between a mobile trading device and a gateway. The gateway is to provide access to one or more markets at an exchange. The example method also includes determining a communication state related to the communication link and comparing the communication state to a communication risk threshold. The communication state reflects an ability of the mobile trading device to communicate with the exchange. If the communication state falls below the communication risk threshold, a risk mitigation action stored at the gateway is initiated.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

A mobile trading device such as, for example, a cell phone, a tablet, etc. is generally in communication with the electronic exchange via a wireless communication network. One or more conditions may affect communication via the mobile trading device such as, for example, a connectivity level of the mobile trading device to the wireless communication network, server latency at a gateway, etc.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an example trading area in accordance with the teachings of this disclosure.

FIG. 5 illustrates an example method to mitigate a communication risk.

FIG. 6 illustrates another example method to mitigate a communication risk.

FIG. 7 illustrates yet another example method to mitigate a communication risk.

FIG. 8 illustrates a block diagram of an example system which may be used to implement the disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to electronic trading systems and, more specifically, mitigating communication risks in an electronic trading system.

Mobile or portable trading devices such as, for example, cell phones, tablets, laptops, etc., may establish a communication link with a gateway (e.g., via a wireless communication network). A state of one or more communication conditions (e.g., a connectivity level of the mobile trading device, memory usage at the gateway, etc.) related to the communication link may affect an ability of the mobile trading device to communicate with an exchange via the gateway. For example, if the connectivity level of the mobile trading device deteriorates (e.g., due to a loss of power of the mobile trading device, a location of the mobile trading device, etc.), the communication between the mobile trading device and the gateway may be interrupted (e.g., delayed, incomplete, and/or substantially impaired).

Embodiments disclosed herein mitigate communication risks in an electronic trading system. Certain embodiments include monitoring the communication link established between the mobile trading device and the gateway and determining a communication state related to the communication link. If the communication state falls below a communication risk threshold, a risk mitigation action is initiated. For example, if the communication state falls below the communication risk threshold, an action stored at the gateway may be performed to enable a user to get flat in a market position.

Certain embodiments disclosed herein determine the communication state based on a location of the mobile trading device. In some examples, a map is generated and/or updated by associating an area with a communication state determined via one or more other mobile trading devices located in the area. If the mobile trading device is located in the area, the mobile trading device is associated with the communication state associated with the area (e.g., according to the map).

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide a method including monitoring a communication link established between a mobile trading device and a gateway. The gateway is to provide access to one or more markets at an exchange. The example method also includes determining a communication state related to the communication link and comparing the communication state to a communication risk threshold. The communication state reflects an ability of the mobile trading device to communicate with the exchange. If the communication state falls below the communication risk threshold, a risk mitigation action stored at the gateway is initiated.

Certain embodiments provide a tangible computer readable storage medium including computer program code that, when executed by a processor, implement a method to mitigate a communication risk. The example method includes at least determining a state of a communication condition of at least one of a portable trading device and a gateway. The portable trading device is to be in communication with an exchange via the gateway. Based on the state, the example method includes performing an action via the portable trading device to mitigate a risk of a market position not closing due to an interruption in communication between the portable trading device and the exchange.

Certain embodiments provide a method including determining a location of a portable trading device. The portable trading device is to be in communication with an exchange. The example method also includes associating the portable trading device with a communication state based on the location and, based on the communication state, performing an action via the portable trading device to mitigate a risk of a market position not closing due to an interruption in communication between the portable trading device and the exchange.

### II. Example Electronic Trading System

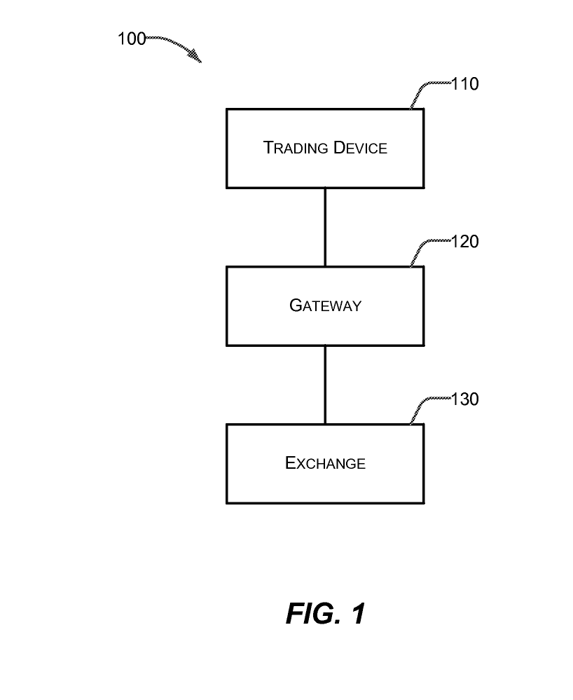

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The example electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

III. EXPANDED EXAMPLE ELECTRONIC TRADING SYSTEM

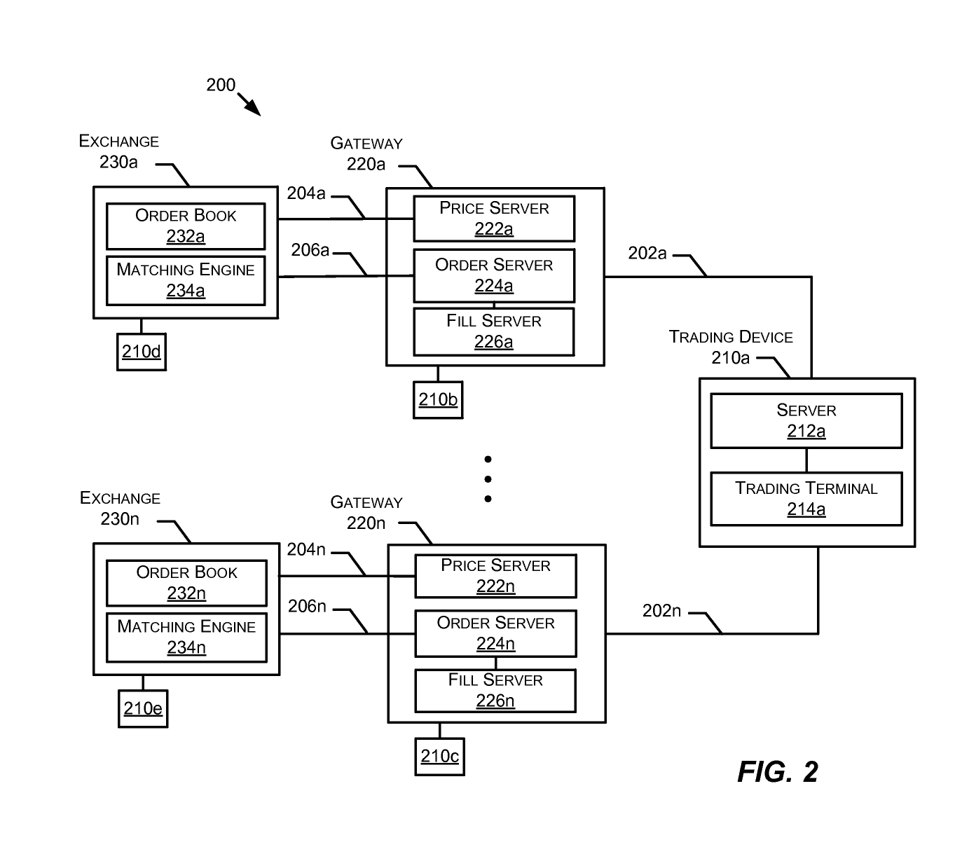

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 120 than the trading terminal 214a. As a result, the server 212a latency benefits that are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components. In some examples, the trading device 210a is a mobile or portable trading device such as, for example, a hand-held device, a laptop, a tablet, a cell phone, a portable computing device, etc.

The trading device 210a may communicate with the gateway 220a using one or more communication networks. As used herein, a communication network is any network, including the Internet, which facilitates or enables communication between, for example, the trading device 210a, the gateway 220a and the exchange 220a. For example, as shown in FIG. 2, the trading device 210a may communicate with the gateway 220a across a multicast communication network 202a. In some examples, the network 202a is a wireless communication network (e.g., a Wi-Fi network, a cellular or mobile network such as, for example, a Global System for Mobile Communications (GSM) network, a Personal Communications Service (PCS) network, a Digital Advanced Mobile Phone Service (D-AMPS) network, a 3G network, a 4G network, and/or any other wireless communication network), which may be terrestrial and/or satellite based. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradeable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book may include data relating to a market for a tradeable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. Example Computing Device

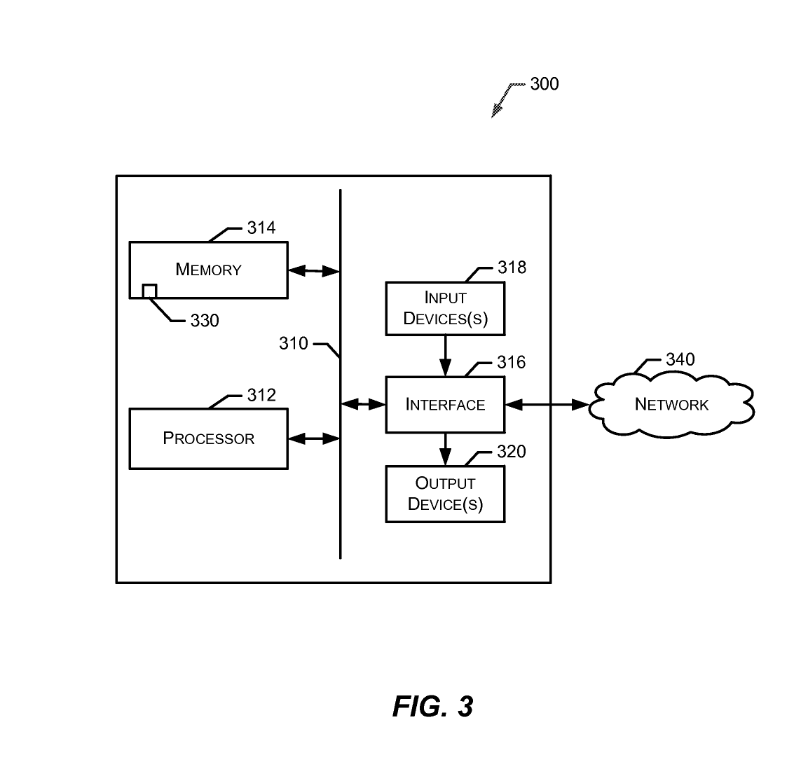

FIG. 3 illustrates a block diagram of an example computing device 300 which may be used to implement the disclosed embodiments. The trading device 110 of FIG. 1 may include one or more computing devices 300, for example. Thus, in some examples, the computing device 300 is mobile or portable. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Mitigating Communication Risks

Example methods to mitigate a communication risk in an electronic trading system are disclosed herein. When a user employs a mobile or portable trading device to communicate with an exchange, a communication link is established between the mobile trading device and a gateway, which provides access to one or more markets at the exchange. The communication link enables the mobile trading device to interact with the gateway. For example, the communication link provides a channel for communication of messages between the mobile device and the gateway via wireless signals of a wireless communication network.

Communication via the mobile trading device may be affected by one or more communication conditions. The communication conditions are functions, characteristics, and/or attributes of the mobile trading device, the gateway, and/or the wireless communication network that enable, affect, and/or support communication between the mobile trading device and the exchange via the communication link. The communication conditions include, for example, a strength of the signal of the wireless communication network received via the mobile trading device (e.g., a connectivity level of the mobile trading device), and latency at a gateway server. A qualitative and/or quantitative measurement, value, and/or status of a communication condition is a state of the communication condition (“a communication state”). If the communication state deteriorates below a minimum threshold state, the communication between the mobile trading device and the exchange may be interrupted (e.g., delayed, incomplete, and/or substantially impaired). Thus, the communication state reflects an ability of the mobile trading device to communicate with the exchange via the communication link.

Certain examples disclosed herein monitor the communication link established between the mobile trading device and a gateway. For example, the mobile trading device may measure a strength of the signal of the wireless communication network received by the mobile trading device. The examples may also include determining a communication state related to the communication link (e.g., a connectivity level of the mobile trading device relative to a maximum possible connectivity level).

In some examples, a communication risk threshold is set (e.g., by a user, automatically by a trading application, etc.). In some examples, the communication risk threshold is a predetermined state of a communication condition at which a given amount of risk is present that the communication between the mobile trading device and the exchange will be interrupted. If the communication state falls below the communication risk threshold, a risk mitigation action may be initiated at the mobile trading device. The risk mitigation action is any action mitigating or performed to mitigate a risk of a market position not closing due to an interruption in the communication link established between the mobile trading device and the exchange. Example risk mitigation actions include generating an alert or warning by the mobile device and providing the alert or warning to a user to indicate that the mobile trading device may not be capable of closing an open market position; executing instructions stored at the gateway to enable the user to get flat in the market position; and uploading or communicating instructions stored on the mobile trading device to the gateway for execution in the event that communications are interrupted. The above-noted risk mitigation actions are merely examples and, thus, other risk mitigation actions may be performed without departing from the scope of this disclosure.

Certain examples disclosed herein determine the communication state based on a location of the mobile trading device. In some examples, the mobile trading device is associated with the communication state based on a map. In some examples, the map includes areas that are associated with communication states. In some examples, the map is generated and/or updated based on communication states communicated via a plurality of other mobile trading devices located in the areas. If the mobile trading device is located in one of the areas, the mobile trading device may be associated with the communication state associated with that area.

As described in conjunction with FIG. 2 above, the example trading device 210a may be a mobile or portable trading device such as, for example, a hand-held device, a laptop, a tablet, a cell phone, a portable computing device, etc. In some such examples, the network 202a is a wireless communication network (e.g., a Wi-Fi network, a cellular or mobile network such as, for example, a Global System for Mobile Communications (GSM) network, a Personal Communications Service (PCS) network, a Digital Advanced Mobile Phone Service (D-AMPS) network, a 3G network, a 4G network, and/or any other wireless communication network), which may be terrestrial and/or satellite based.

When the trading device 210a is in communication with the gateway 220a, a communication link is established between the gateway 220a and the trading device 210a via the network 202a. The communication link enables the trading device 210a to interact with the gateway 220a, for example, via signals wirelessly communicated via the network 202a. In some examples, the communication link is established when, via the communication link, the trading device 210a is capable of communicating with the gateway 220a, and/or the gateway 220a is capable of responding to instructions communicated to the gateway 210a via the trading device 210a.

One or more communication conditions of the trading device 210a and/or the gateway 220a are related to the communication link. The communication conditions are functions, characteristics, and/or attributes of the trading device 210a, the gateway 220a, and/or the network 202a that enable, affect, and/or support communication between the trading device 210a and the exchange 230a via the communication link. The communication conditions include, for example, a strength of the signal of network 202a received by the trading device 220a (e.g., a connectivity level of the trading device 210a), a remaining battery life of the trading device 210a, latency at the gateway 220a, an amount of memory utilization of the trading device 210a and/or the gateway 210a, a CPU load at the gateway 220a, and/or other communication condition(s).

A qualitative and/or quantitative measurement, value, and/or status of a communication condition is a state of the communication condition (“a communication state”). The state of each of the communication conditions reflects an ability of the trading device 210a to communicate with the exchange 230a. If the state of a communication condition reaches or falls below a minimum threshold state, the communication between the trading device 210a and the exchange 230a may be interrupted (e.g., delayed, incomplete, and/or substantially impaired). If a market position is open when the state of the communication condition is at or below the minimum threshold state, the market position may not be able to be closed via the trading device 210a. For example, the minimum threshold state may include a lack of remaining battery life of the trading device 210a, insufficient connectivity, and/or other communication condition that may prevent or delay the trading device 210a from communicating instructions to the gateway 220a to close the market position. Thus, a deterioration of the state of the communication condition may present and/or increase a risk of a market position not closing due to an interruption in communication between the trading device 210a and the exchange 230a. A failure to close a market position can, for example, result in a loss of money, a lost opportunity, and an incorrect trade.

To mitigate the risk, a risk mitigation action is initiated if the communication state falls below a communication risk threshold (e.g., below a threshold state). In some examples, the communication risk threshold is a predetermined state of a communication condition at which a given amount of risk is present that the communication between the trading device 220a and the exchange 230a will be interrupted. In some examples, the communication risk threshold corresponds to the minimum threshold state (e.g., a state of a communication condition at which the communication between the trading device 210a and the gateway 220a is interrupted). In other examples, the communication risk threshold corresponds to a state of the communication condition above the minimum threshold state (e.g., a state at which the trading device 210a is capable of communicating with the gateway 220a via the network 202a) to enable, for example, the trading device 220a to communicate instructions to the gateway 220a to perform one or more risk mitigation actions.

The risk mitigation action is any action mitigating or performed via the trading device 210a and/or the gateway 220a to mitigate a risk of a market position not closing due to an interruption in the communication link established between the trading device 210a and the exchange 230a. In some examples, the risk mitigation action includes executing instructions stored at the gateway 220a to enable a user to get flat in a market position (e.g., communicate with the exchange 230a to perform a transaction, reject a trade message, etc. to prevent the user from having a surplus or deficit of a commodity), providing a message (e.g., an alert, a warning, a prompt) to the user, and/or performing any other risk mitigation action. In some examples, the risk mitigation action includes preventing a position from being opened via the trading device 210a.

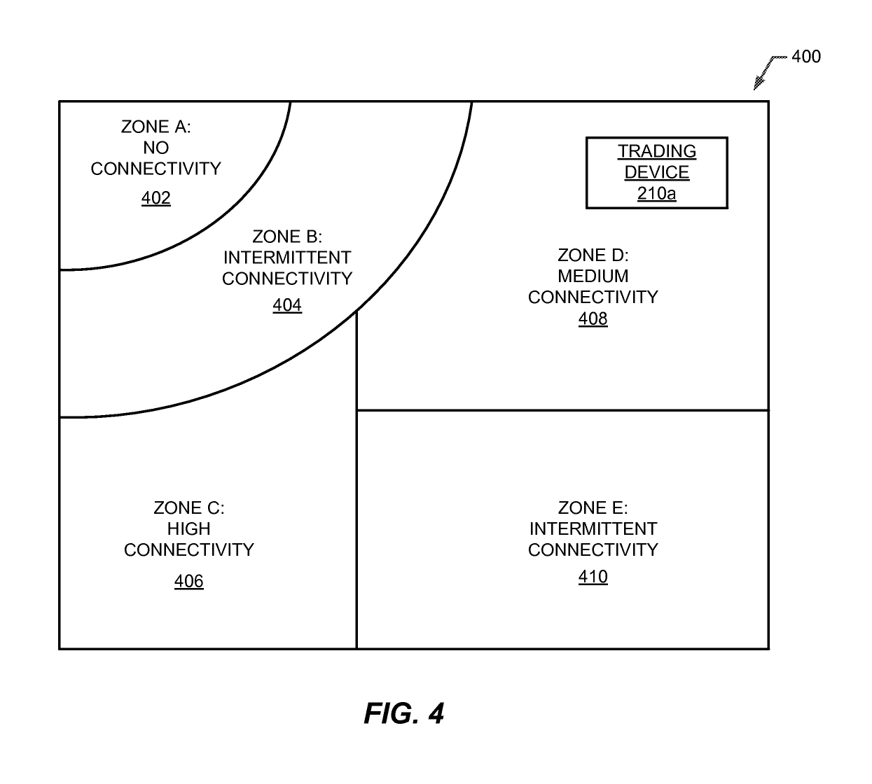

For example, the communication link between the trading device 210a and the gateway 220a may be monitored by measuring the connectivity at the trading device 210a (e.g., substantially continuously, at predetermined intervals of time, based on a location of the trading device 210a as described in more detail in conjunction with FIG. 4 below, etc.). In some examples, the communication risk threshold may be set at a given percentage of a maximum possible signal strength to be received by the trading device 210a. If the trading device 210a detects a signal having a strength at or below the given percentage, a risk mitigation action stored at the trading device 210a and/or gateway 220a is initiated. For example, the risk mitigation action may include providing an alert indicating that a market position may not be capable of being closing via the trading device 210a, executing instructions stored at the gateway 220a to enable a user to get flat in a market position, etc.

FIG. 4 illustrates an example area 400 in which the trading device 210a may be located. In the illustrated example, the area 400 includes a plurality of zones 402, 404, 406, 408, 410. Each of the example zones 402, 404, 406, 408, 410 defines a geographic region as a function of a communication condition evaluated with respect to the trading device 210a. In the illustrated example, the communication condition is a connectivity level of the trading device 210a to the network 202a. For example, Zone A 402 is associated with no connectivity; Zone B 404 is associated with intermittent connectivity; Zone C 406 is associated with high connectivity, etc. In other examples, the zones 402, 404, 406, 408, 410 are associated with other states and/or communication conditions such as the signal-to-noise ratio, and the type of network available. The example zones 402, 404, 406, 408, 410 may correspond to buildings, streets, cities, areas defined by global positioning system (“GPS”) coordinates, and/or any other type of area.

In the illustrated example of FIG. 4, a state of a communication condition is determined based on a location of the trading device 210a. In some examples, the trading device 210a determines its location via a GPS tracking device and/or with respect to another device. If the trading device 210a is located in one of the zones 402, 404, 406, 408, 410, the trading device 210a is associated with a state of the communication condition (e.g., a connectivity level) of the zone 402, 404, 406, 408, 410 in which the trading device 210a is located. For example, if the trading device 210a determines that it is located in Zone D 408, the trading device 210a is associated with the communication state that is associated with Zone D 408: medium connectivity. If medium connectivity is at or below the communication risk threshold, a risk mitigation action is initiated. In some examples, if the trading device 210a is within a predetermined distance (e.g., five hundred feet) from a zone associated with a communication state at or below the communication risk threshold, the risk mitigation action is initiated. For example, a message (e.g., an alert, a warning, etc.) may be provided via the trading device 210a indicating that the trading device 210a is located near the zone associated with the communication state at or below the communication risk threshold.

In the illustrated example, a map is generated (e.g., the zones 402, 404, 406, 408, 410 are determined and/or associated with the communication conditions) based on communication states and trading device locations communicated by a plurality of mobile trading devices including the trading device 210a and other mobile trading devices. For example, each of the mobile trading devices monitors a communication state and its location and communicates the communication state and its location to a central location such as, for example, the gateway 220a. Based on the communication states and the locations, a host generates and/or updates the map. In some examples, the map includes a table, a matrix, and/or a database, etc. that includes the communication states and the device locations. In some examples, the map includes a graphical representation of a given area. The map may be communicated to the mobile trading devices to enable the mobile trading devices to assess communication risks (e.g., compare the communication state with a communication risk threshold) based on their locations and the map.

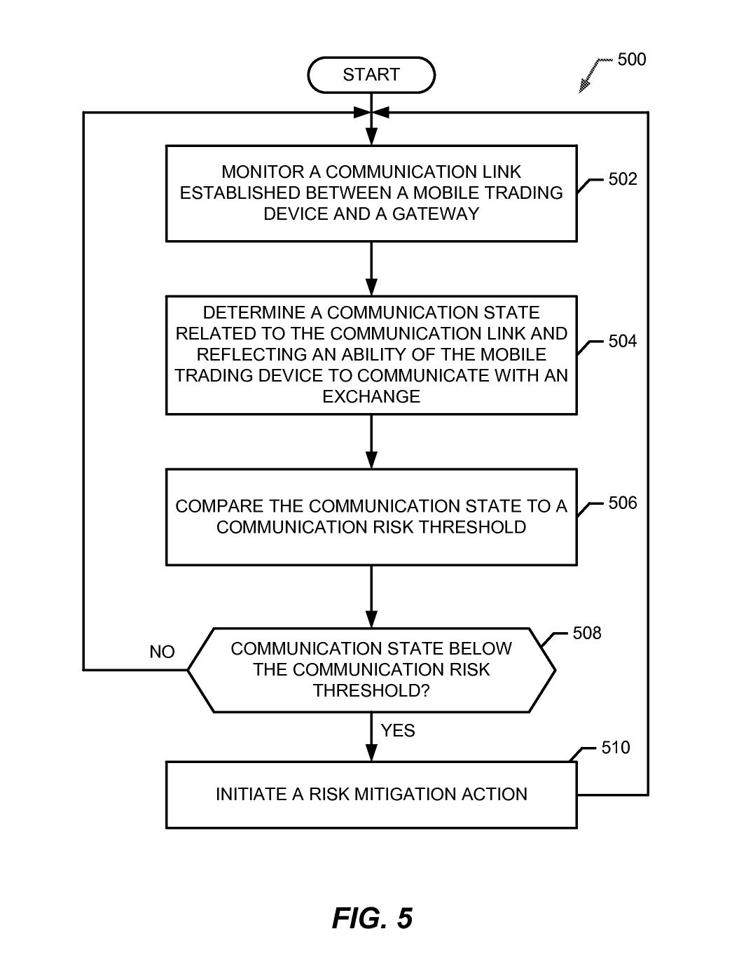

FIG. 5 illustrates an example method 500 to mitigate a communication risk in an electronic trading system. The example method 500 may be performed by any mobile trading device (e.g., the trading device 110 of FIG. 1, the trading device 210a of FIG. 2, etc.) and/or gateway (e.g., the gateway 120 of FIG. 1, the gateway 220a of FIG. 2, the gateway 220n of FIG. 2, etc.). The example method 500 begins by monitoring a communication link established between a mobile trading device and a gateway (block 502). In some examples, the communication link is monitored by evaluating a communication condition of mobile trading device such as, for example, a connectivity level of the mobile trading device with a wireless communication network. In some examples, the communication link is monitored by evaluating a location of the mobile trading device. In some examples, the communication condition monitored includes a remaining battery life of the mobile trading device, a memory utilization of the mobile trading device, and/or any other communication condition(s) of the mobile trading device. In some examples, the communication link is monitored my evaluating a communication condition of the gateway such as, for example, latency at the gateway 220a, an amount of memory utilization of the gateway 210a, a CPU load at the gateway 220a, and/or any other communication condition(s). In some examples, more than one communication condition of the mobile trading device and/or the gateway is monitored.

A communication state related to the communication link and reflecting an ability of the mobile trading device to communicate with an exchange is determined (block 504). For example, the communication state may include a measured connectivity of the mobile trading device relative to a maximum possible connectivity, an estimated time remaining in a life of a battery of the mobile trading device, a percentage of available memory being used at the gateway, etc. In some examples, the communication state is determined based on a location of the mobile trading device. For example, if the mobile trading device is located in Zone D 408 of FIG. 4, the communication state is determined to be the communication state associated with Zone D 408: medium connectivity.

The communication state is compared to a communication risk threshold (block 506). For example, the communication risk threshold may be a predetermined communication state such as, for example, medium connectivity, a remaining ten percent of battery life of the mobile trading device, a given latency at the gateway, and/or any other desired communication risk threshold. If the communication state is below the communication risk threshold (block 508), a risk mitigation action is initiated (block 510). In some examples, the risk mitigation action is initiated at the gateway. For example, instructions stored at the gateway may be executed to enable a market position taken by a user of the mobile trading device to go flat, the gateway may prevent a market position from being opened via the mobile trading device, etc. In other examples, additionally or alternatively, a risk mitigation action is initiated at the mobile trading device. For example, the mobile trading device may generate and/or display an alert or warning indicating that the communication state fell below the communication risk threshold, a trading application may prevent a market position from being opened via the mobile trading device, etc. If the communication state has not fallen below the communication risk threshold, the example method returns to block 502.

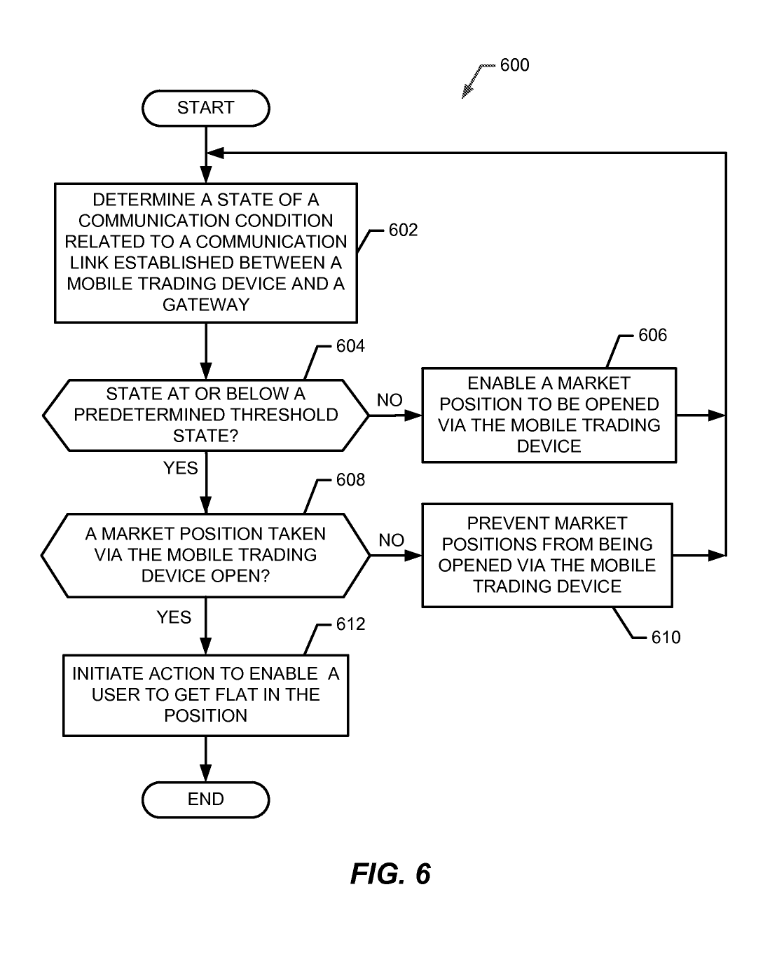

FIG. 6 illustrates another example method 600 to mitigate a communication risk in an electronic trading system. The example method 600 may be performed by any mobile or portable trading device (e.g., the trading device 110 of FIG. 1, the trading device 210a of FIG. 2, etc.) and/or gateway (e.g., the gateway 120 of FIG. 1, the gateway 220a of FIG. 2, the gateway 220n of FIG. 2, etc.). The example method 600 of FIG. 6 begins by determining a state of a communication condition related to a communication link established between a mobile trading device and a gateway (block 602). In some examples, the mobile trading device and/or the gateway monitors one or more communication conditions such as, for example, a connectivity level of the mobile trading device, a remaining battery life of the trading device 210a, latency at the gateway 220a, an amount of memory utilization of the trading device 210a and/or the gateway 210a, a CPU load at the gateway 220a, and/or other communication condition(s).

The example method 600 determines if the state is at or below a predetermined threshold state (block 604). If the state is above the predetermined threshold state (e.g., a state corresponding to a communication risk threshold), opening a market position via the mobile trading device is enabled (block 606), and the example method returns to block 602. If the state is at or below the predetermined threshold state, the example method 600 determines if a market position taken via the mobile trading device is open (block 608). In some examples, whether or not the market position is open (or unfilled) is determined via an application stored on the mobile trading device. In other examples, whether or not the market position is open is determined via the gateway. If no market position is open, market positions are prevented from being opened via the mobile trading device (block 610). For example, a trading application stored on the mobile trading device prevents the market position from being opened, one or more applications stored on the gateway prevents the market position from being opened via the mobile trading device, etc. The example method then returns to block 602.

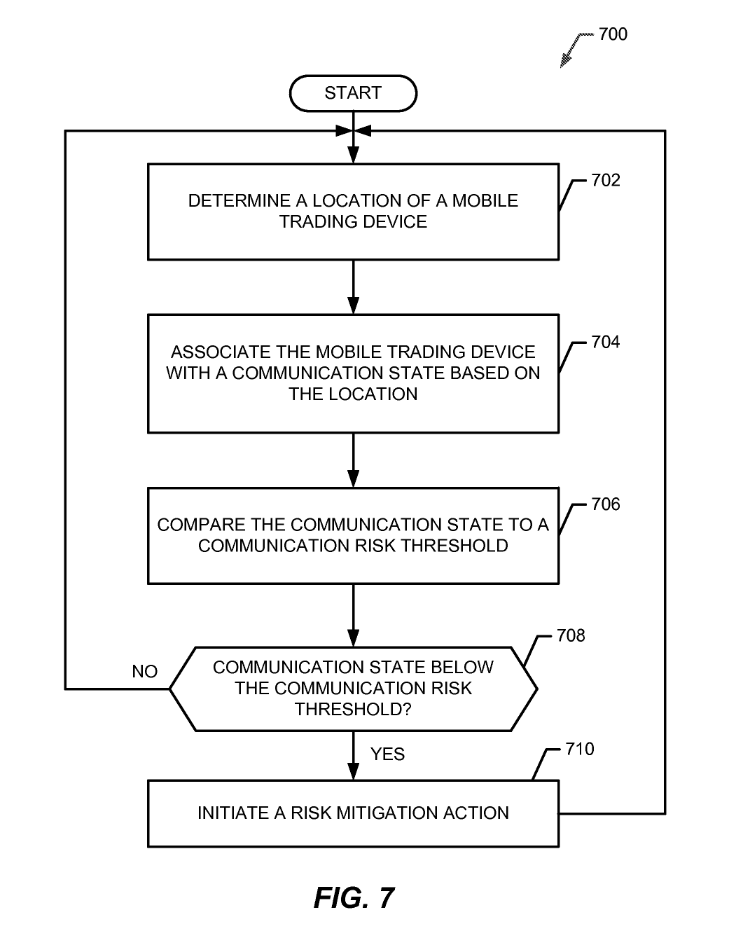

If a market position taken via the mobile trading device is open, an action is initiated to enable a user to get flat in the position (block 612). For example, a trade message may be accepted via the gateway to prevent a user from having a surplus or deficit of a commodity. In other examples, additionally or alternatively, one or more other risk mitigation actions stored at the gateway and/or the mobile trading device is initiated (e.g., an alert is provided via the mobile trading device, etc.). FIG. 7 illustrates another example method 700 to mitigate a communication risk in an electronic trading system. The example method 700 may be performed by any mobile trading device (e.g., the trading device 110 of FIG. 1, the trading device 210a of FIG. 2, etc.) and/or gateway (e.g., the gateway 120 of FIG. 1, the gateway 220a of FIG. 2, the gateway 220n of FIG. 2, etc.). FIG. 7 begins by determining a location of a mobile trading device (block 702). In some examples, the mobile trading device includes a tracking device such as, for example, a GPS tracking device, and the mobile trading device determines its position via the tracking device.

The mobile trading device is associated with a communication state based on the location (block 704). In some examples, a map is generated and/or updated at a central location (e.g., the gateway, a host on a wireless communications network, etc.) based on communication states and mobile trading device positions communicated to the central location by a plurality of mobile trading devices. The map may associate an area with a communication state. In some examples, the central location communicates the map to the mobile trading device. If the mobile trading device is located in an area covered by the map, the communication state associated with the mobile trading device is determined to be the communication state associated with the area in which the mobile trading device is located. For example, if the mobile trading device is located in a location corresponding to Zone B 404 of FIG. 4, the mobile trading device is associated with the communication state intermittent connectivity.

The communication state is compared to a communication risk threshold (block 706). If the communication state is below the communication risk threshold, (block 708), a risk mitigation action is initiated (block 710). For example, if the communication risk threshold is set at medium connectivity and the communication state is determined to be low connectivity, the risk mitigation action is initiated. In some examples, the risk mitigation action is initiated at the gateway. For example, instructions stored at the gateway may be executed to enable a user to get flat in a market position. In other examples, the risk mitigation action is initiated at the mobile trading device. For example, the mobile trading device may generate and/or display an alert indicating that the communication state fell below the communication risk threshold, and/or a trading application stored on the mobile trading device may prevent a market position from being opened via the mobile trading device. In some examples, instructions stored on the mobile trading device are uploaded or communicated to the gateway for execution in the event that communications are disrupted. The example method 700 then returns to block 702. If the communication state has not fallen below the communication risk threshold as determined at block 708, the example method 700 returns to block 702.

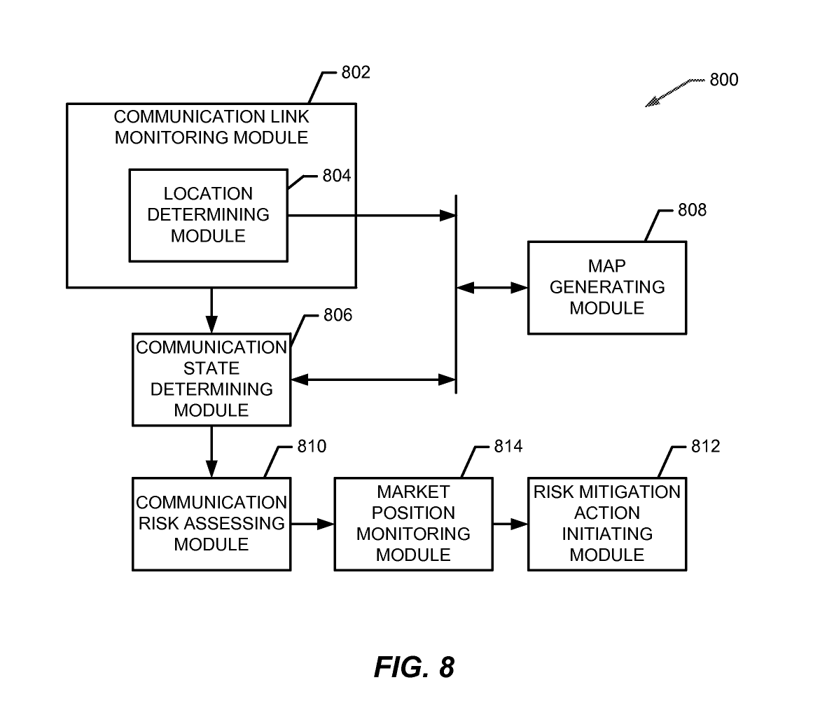

FIG. 8 is a block diagram of an example system 800 that may implement and/or execute the example operations of FIGS. 5-7. In some examples, the system 800 may be implemented as part of software (or an application) associated with the trading device 110 of FIG. 1, the trading device 220a of FIG. 2, gateway 120 of FIG. 1, the gateway 220a of FIG. 2 and/or the gateway 220n of FIG. 2. In some examples, the system 800 may be implemented as computer implemented code or instructions operable independent of software associated with the trading device 110, the trading device 220a, the gateway 120, the gateway 220a and/or the gateway 220n. In some examples, the features and functionality of the system 800 may be implemented in hardware operable in connection with the trading device 110, the trading device 220a, the gateway 120, the gateway 220a and/or the gateway 220n.

The example system 800 of FIG. 8 includes a communication link monitoring module 802 to monitor a communication link established between a mobile trading device and a gateway in communication with an exchange. For example, the communication link monitoring module 802 may monitor the communication link by monitoring a communication condition of the mobile trading device, the gateway and/or a wireless communication network such as a connectivity level of the mobile trading device with the wireless communication network (e.g., the network 202a), a remaining battery life of the mobile trading device, a latency of one or more servers at the gateway, an amount of memory being utilized by the gateway, etc. In some examples, the communication link monitoring module 802 monitors the communication link by monitoring a location of the mobile trading device. In the illustrated example, the communication link monitoring module 802 includes a location determining module 804 to determine a location of the mobile trading device.

The example system 800 of FIG. 8 includes a communication state determining module 806. In some examples, the communication state determining module 806 determines a state of the communication condition by making, evaluating and/or determining a qualitative and/or quantitative measurement, value and/or status of the communication condition. Some example communication states include a connectivity level relative to a maximum possible connectivity level, an estimated amount of time remaining in a life of a battery of the mobile trading device, a percentage of total available memory being used by a server at the gateway, etc. In some examples, the communication state determining module 806 determines the communication state based on the location of the mobile trading device determined via the location determining module 804 and a map generated via a map generating module 808.

The map generating module 808 receives mobile trading device locations and communication states from a plurality of mobile trading devices. In some examples, the location determining module 804 communicates a location of the mobile trading device to the map generating module 808, and the communication state determining module 806 communicates a communication state to the map generating module 808. The map generating module 808 may associate the communication state with the location. Based on the location and the communication state, the map generating module 808 generates and/or updates a map in which an area is associated with the communication state. In some examples, the map includes a plurality of areas associated with a plurality of communication states. If the mobile trading device is located in one of the areas, the communication state determining module 806 associates the mobile trading device with the communication state associated with the area.

The example system 800 includes a communication risk assessing module 810 to determine if the communication state is below a communication risk threshold, which may be set by a user or a trading application. In some examples, the communication risk threshold corresponds to a minimum threshold state at which communication between mobile trading device and the gateway is interrupted (e.g., delayed, incomplete, and/or substantially impaired). In other examples, the communication risk threshold corresponds to a state of the communication condition above the minimum threshold state.

In the illustrated example, a risk mitigation action initiating module 812 of the example system 800 of FIG. 8 initiates a risk mitigation action if the communication state is below the communication risk threshold. In some examples, a type of risk mitigation action performed is based on whether a market position taken via the mobile trading device is open. A market position monitoring module 814 of the example system 800 of FIG. 8 monitors market positions taken via the mobile trading device. If a market position has been taken, the market position monitoring module 814 determines if the market position is open. In some examples, if the market position is open, the risk mitigation action initiating module 812 initiates one or more actions to enable a user of the mobile trading device to get flat in the market position. In some examples, if the market position is not open, the risk mitigation action initiating module 812 prevents any positions from being opened via the mobile trading device (e.g., until the communication state returns to a state above the risk communication threshold). In some examples, additionally or alternatively, the risk mitigation action initiating module 812 performs one or more other actions such as, for example, providing an alert or warning to the user.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method, comprising:
monitoring a communication link established between a mobile trading device and a gateway, wherein the gateway is to provide access to one or more markets at an exchange;
determining a communication state related to the communication link, wherein the communication state reflects an ability of the mobile trading device to communicate with the exchange;
comparing the communication state to a communication risk threshold; and
initiating, if the communication state falls below the communication risk threshold, a risk mitigation action stored at the gateway.

2. A method of claim 1 wherein the risk mitigation action comprises communicating instructions to the gateway to enable a user to go flat in a market position.

3. A method of claim 1 wherein the risk mitigation action comprises providing an alert.

4. A method of claim 1 wherein monitoring the communication link comprises determining a signal strength via the portable trading device.

5. A method of claim 1 wherein monitoring the communication link comprises determining a remaining battery life of the portable trading device.

6. A method of claim 1 wherein monitoring the communication link comprises determining an amount of memory being utilized by the gateway.

7. A method of claim 1 further comprising:
associating the state of the communication condition with a location of the portable trading device; and
via a network, communicating the state of the communication condition and the location to enable a map to be updated.

8. A method of claim 1 wherein determining the state of the communication condition comprises:
determining a location of the portable trading device; and
determining the state associated with the location.

9. A tangible computer readable storage medium including computer program code to be executed by a processor, the computer program code, when executed, to implement a method to mitigate a communication risk, the method comprising:
determining a state of a communication condition of at least one of a portable trading device and a gateway, the portable trading device in communication with an exchange via the gateway; and
based on the state, perform an action via the portable trading device to mitigate a risk of a market position not closing due to an interruption in communication between the portable trading device and the exchange.

10. A tangible computer readable storage medium as described in claim 9 wherein the action comprises providing a warning.

11. A tangible computer readable storage medium as described in claim 9 wherein the communication condition comprises a connectivity level of the portable trading device.

12. A tangible computer readable storage medium as described in claim 9 wherein the action comprises preventing a market position from being opened via the portable trading device.

13. A tangible computer readable storage medium as described in claim 9 further comprising:
determining a location of the portable trading device; and
via a network, communicating the state and the location to enable a map to be updated.

14. A tangible computer readable storage medium as described in claim 9 wherein the state of the communication condition is determined based on a location of the portable trading device.

15. A method, comprising:
determining a location of a portable trading device, the portable trading device to be in communication with an exchange;
based on the location, associating the portable trading device with a communication state; and
based on the communication state, perform an action via the portable trading device to mitigate a risk of a market position not closing due to an interruption in communication between the portable trading device and the exchange.

16. A method of claim 15 wherein associating the portable trading device with the communication state comprises associating the portable trading device with the communication state based on a map.

17. A method of claim 16 wherein the map is based on at least one previously determined communication state of another portable trading device.

18. A method of claim 15 wherein the action comprises communicating a command to the gateway to enable a user to get flat in a market position.

19. A method of claim 15 wherein the action comprises providing an alert.

20. A method of claim 15 wherein the action comprises preventing a market position from being opened.
